(19) United States
(12) Patent Application Publication
(10) Pub. No.: US 2018/0170789 A1
(43) Pub. Date: Jun. 21, 2018

(54) SELF-SUPPORTED INORGANIC SHEETS, ARTICLES, AND METHODS OF MAKING THE ARTICLES

(71) Applicant: Corning Incorporated, Corning, NY (US)

(72) Inventors: William Peter Addiego, Big Flats, NY (US); Daniel Robert Boughton, Naples, NY (US); Jennifer Anella Heine, Hammondsport, NY (US); Kenneth Edward Hrdina, Horseheads, NY (US); Paul Oakley Johnson, Corning, NY (US)

(21) Appl. No.: 15/836,286

(22) Filed: Dec. 8, 2017

Related U.S. Application Data
(60) Provisional application No. 62/436,130, filed on Dec. 19, 2016.

(51) Int. Cl. C03B 19/14; B05B 7/22

(52) U.S. Cl. CPC C03B 19/1446; B05B 7/22; C03B 19/1492

(57) ABSTRACT

A method of making a self-supporting inorganic sheet, including:
electrostatically depositing a dry inorganic powder on a surface to form an inorganic layer on the surface; and
sintering the resulting inorganic layer to form a self-supporting sintered inorganic sheet. The method can additionally include, for example, separating of the self-supporting sintered inorganic sheet from the surface, optionally contacting the separated sintered inorganic sheet with a coupling agent, infiltrating the separated sintered inorganic sheet with a polymer with or without contacting with a coupling agent, or a combination thereof. Also disclosed is a sheet article made by the method.

This application claims the benefit of priority under 35 U.S.C. § 119 of U.S. Provisional Application Ser. No. 62/436,130 filed on Dec. 19, 2016 the content of which is relied upon and incorporated herein by reference in its entirety.

### CROSS-REFERENCE TO RELATED APPLICATIONS

The present application is related commonly owned and assigned copending U.S. Provisional Application Ser. No. 62/113,830, filed on Feb. 9, 2015, entitled “SPINEL SLURRY AND CASTING PROCESS,” which mentions a ceramic and polymer composite, and methods of making and using the composite. The content of this document is incorporated by reference but the present disclosure does not claim priority thereto.

The entire disclosure of each publication or patent document mentioned herein is incorporated by reference.

### BACKGROUND

The disclosure relates to a method of making porous or dense glass or ceramic sheets.

### SUMMARY

In embodiments, the disclosure provides a sintered or unsintered self-supporting inorganic sheet article.

In embodiments, the disclosure provides a method of making a self-supporting sintered inorganic sheet, comprising:

electrostatically depositing a dry inorganic powder on a surface to form an inorganic layer on the surface;

sintering the resulting inorganic layer to form a self-supporting sintered inorganic sheet.

In embodiments, the disclosure provides a method of making sintered or unsintered self-supporting inorganic sheet that can further include, for example, separating the sintered or unsintered sheet from the surface, sintering, contacting the sheet with a coupling agent, infiltrating the self-supporting sintered inorganic sheet with a polymer, or combinations thereof.

### BRIEF DESCRIPTION OF THE DRAWINGS

In embodiments of the disclosure:

FIG. 1 shows an exemplary porous silica microstructure of the disclosure created by electrostatic spray deposition of silica soot on Pt foil, and then sintering at 1392° C.

FIG. 2 shows an exemplary unique porous silica microstructure created by electrostatic spray deposition of silica soot on a Grafoil® surface, and then sintering at 1392° C.

FIGS. 3 and 4 show examples of flat and flexible porous silica self-supporting sheets created by electrostatic spray deposition of silica soot, and then sintering at 1392° C.

FIG. 5 shows silica soot after sintering to 1392° C. in helium on a Grafoil® surface having a thickness of approximately 100 microns.

FIG. 6 shows silica soot that was electrostatically sprayed on a Grafoil® surface.

FIG. 7 shows electrostatically deposited silica soot after sintering to 1392° C. in helium on platinum foil and having a thickness of approximately 100 microns.

FIG. 8 shows a 250 micron porous, self-supporting, silica sheet after sintering to 1400° C. on Grafoil® using Daraclar® silica gel mixed with silica soot (21 m²/g).

FIG. 9 shows an image of an electrostatic spray deposition apparatus using a corona gun to generate electric field and where the receiving surface is grounded.

FIG. 10 shows a schematic for providing an opposing charge on the receiving surface such as a stainless steel plate.

FIG. 11 shows a multi-port powder corona charging system.

FIG. 12 shows an in-line corona charging head having fluidized particle injection connections.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed method of making and using provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### Definitions

“Self supporting” or like terms refer to a sheet that can be removed from a deposition surface and is able to stand on its side or edge, i.e., free standing, on its own, i.e., without additional support. The self-supporting sheet can be physically or mechanically handled and can be subjected to further processing without cracking or the introduction of defects and without the support of the substrate. The formed sheet can then be sintered, consolidated, or both, and then released from the substrate to produce a free standing sheet. The self-supporting sheet can be treated with a coupling agent. The self-supporting sheet can be infiltrated with a polymer, with or without coupling agent treatment.

“Composite” or like terms refer to a porous inorganic phase and a polymer phase occupying the porous volume of the inorganic phase.

“Coupled-polymer-sheet” or like terms refer to a composite that has be pretreated with a coupling agent prior to filling the porous volume of the inorganic phase with a polymer.

“Flexible”, “flexiblity”, or like terms refer to a minimum bend radius without breakage, for example, a bend radius of from 10 mm to 1000 cm, such as less than about 1000 cm, less than about 100 cm, or even less than about 50 cm, including intermediate values and ranges.

“Porous”, “porosity”, or like terms refer to a conventional void volume and can be, for example, from 0.1 to 80%, and from 20 to 60% porosity, including intermediate values and ranges. “Porous”, or like terms refers to a sheet having greater than 0% porosity, such as from 0.01 to 60% porosity, including intermediate values and ranges.

“Dense”, or like terms refer to a sheet having less than 1 defect per 1 m², or for example, of from 90 to 95% optical transmission or greater optical transmission.

“Consolidation”, “consolidated”, and like terms refer to a sheet article that is highly sintered and “dense”, for example, having less than 1 defect per 1 m², or for example, of from 90 to 95% optical transmission or more, or being hermetic.

“Pre-sinter”, “pre-sintered”, and like terms refer to partial sintering to the point where the sheet is strong enough to be handled and undergo further processing without introducing defects.

“Include,” “includes,” or like terms means encompassing but not limited to, that is, inclusive and not exclusive.

“Surface”, “deposition surface,” or like terms refer to a support member that receives the electrostatically deposited particles. The surface can be, for example, planar (i.e., flat), curved, contoured, or a combination thereof.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

WO2013177029 (U.S. Pat. No. 9,199,870) mentions forming a high-surface quality glass sheet using a roll-to-roll glass soot deposition and sintering process. The glass sheet formation involves providing glass soot particles, depositing a first fraction of the glass soot particles on a deposition surface to form a supported soot layer, electrostatically attracting and collecting a second fraction of the glass soot particles onto a surface of a charged plate, removing the soot layer from the deposition surface to form a soot sheet, and heating at least a portion of the soot sheet to sinter the glass soot particles to form a glass sheet.

WO2010059896 mentions using electrostatics to coat a glass substrate during drawing, more specifically, methods for coating a glass substrate as it is being drawn, for example, during fusion draw or during fiber draw are mentioned. The coatings are conductive coatings which can also be transparent. The conductive thin film coated glass substrates can be used in, for example, display devices, solar cell applications, and other applications.

Bao has mentioned a process in which zirconia films were created by electrostatic powder coating. This film was then modified by adding a nanopowder, zirconia suspension to create a thin, dense film coating on a porous substrate (see Bao, et al., 2005. Dense YSZ electrolyte films prepared by modified electrostatic powder coating. Solid State Ionics 176:669-674).

Balachadran has mentioned an electrostatic spray process that was used to create uniform ZrO₂ and SiC thin film coatings (see W. Balachadran, et al., Electrospray of fine droplets of ceramic suspensions for thin-film preparation. Journal of Electrostatics. 50: 249-263, 2001.).

Yu has mentioned the use of electrostatics to make porous ceramic films using a wet suspension containing a metal oxide powder (see Y. Yu, et al., Highly Porous Spongelike Ceramic Films with Bimodal Pore Structure Prepared by Electrostatic Spray Deposition Technique Aerosol Science and Technology 39:276-281, 2005).

Forming thin metal oxide self-supporting sheets that are flat and uniform present challenges including, for example, the sheet can become warped after sintering or have poor uniformity attributable to uneven shrinkage caused by, for example, density variations in the green body or temperature variability in a furnace.

In embodiments, the disclosure provides a self-supporting, porous or dense, glass or ceramic, sheet.

In embodiments, the disclosure provides a method of making a self-supporting porous or dense, glass or ceramic sheet.

In embodiments, the disclosure provides a method for making a thin, glass or ceramic, self-supporting sheet or layer using an electrostatic spray deposition technique.

In embodiments, the disclosure provides a method of making a self-supporting sintered inorganic sheet or layer, comprising:

electrostatically depositing a dry inorganic powder on a surface to form an inorganic layer on the surface; and

sintering the resulting inorganic layer to form a self-supporting sintered inorganic sheet.

In embodiments, the disclosure provides a method of making a self-supporting metal oxide sheet, comprising:

electrostatically depositing a dry metal oxide powder on a surface to form a metal oxide sheet or layer; and

sintering the resulting metal oxide sheet or layer to form a self-supporting sintered metal oxide sheet layer.

In embodiments, the self-supporting sintered inorganic sheet can be, for example, 40 to 100% dense.

In embodiments, the self-supporting sintered inorganic sheet can be, for example, 60 to 0% porous.

In embodiments, the self-supporting sintered inorganic sheet can be, for example, from 40 to 100% dense and from 60 to 0% porous.

In embodiments, the dry inorganic powder can be, for example, a source of at least one of a glass, a metal oxide, a metal carbide, a metal nitride, and like materials, or a mixture thereof.

In embodiments, the method can further comprise, for example, separating, prior to sintering, the inorganic layer from the surface to afford the self-supporting inorganic sheet or self-supporting metal oxide sheet.

In embodiments, the method can further comprise, for example, separating, after sintering, the sintered inorganic sheet from the surface to provide the self-supporting sintered inorganic sheet.

In embodiments, the method can further comprise, for example, prior to electrostatically depositing the dry inorganic powder, the dry inorganic powder is fluidized and electrostatically charged.

In embodiments, the method can further comprise, for example, infiltrating the self-supporting sintered inorganic sheet with at least one polymer. In embodiments, the at least one polymer can be selected, for example, from at least one of a polymer melt, a cross-linkable polymer, e.g., a thermoset, a thermoplastic, thermal or UV curable polymer, and like polymers, or a combination thereof. In embodiments, the at least one polymer has a refractive index that is the same or similar to the refractive index of the self-supporting inorganic sheet.

In embodiments, the method can further comprise, for example, contacting the self-supporting inorganic sheet with a coupling agent, and then infiltrating the coupling agent contacted self-supporting inorganic sheet with a polymer. Coupling agents and extensive coupling chemistry are known in the art (see for example, Silane Coupling Agents, 1991, 2^{nd} Edition by E. P. Plueddemann, Springer, ISBN-10: 0306434733), and are commercially available (e.g., Dow Chemical, Sibond, Gelest (gelest.com)). One example coupling agent is 3-(triethoxysilyl)propyl methacrylate of the formula:

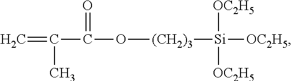

which compound, or its hydrolyzed trihydroxy equivalent, can react on the Si end with inorganic surface moieties, and subsequently react with an infiltrated polymer on the olefin end (i.e., the organofunctional group). Coupling agents can effect a covalent bond between organic (i.e., the infiltrated polymer) and inorganic materials (i.e., the porous sheet). Another example coupling agent is strylethyltrimethoxysilane of the formula:

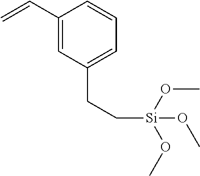 [SMILES: C=Cc1cccc(CC[Si](OC)(OC)OC)c1]

which compound, or its hydrolyzed trihydroxy equivalent, can be used with a free radical initiated polymerization of, for example, styrene monomer to produce a coupled polystyrene within the porous inorganic sheet.

The contacting of the self-supporting inorganic sheet with a coupling agent is advantaged by, for example: compatibilizing the interstitial surfaces of the inorganic sheet to receive and optionally bond with the infiltrated polymer; to provide greater penetration and uniform distribution of the infiltrated polymer; and to provide enhanced strength, durability, and utility properties to the resulting coupling agent contacted, polymer infiltrated, self-supporting sheet article (“coupled-polymer-sheet” or “composite”). The coupled-polymer-sheet article or composite article and the method of making can be used in display applications where, for example, the infiltrated polymer is index matched to a porous sheet or porous substrate, the composite article (i.e., the inorganic and organic composite) can have, for example, a 3 mm bend radius and can pass a 10 cm pen drop test. The composite article and the method of making the composite article can also be used in microelectronic (e.g., PCB) applications where the composite must have a low loss tangent of, for example, 1×10⁻⁴, withstand temperatures of up to, for example, 280° C., and have a fracture toughness and strength that can withstand, for example, drilling of copper vias without blur or fracture.

In embodiments, the method can further comprise, for example, chemical strengthening of the self-supporting sintered inorganic sheet, e.g., ion-exchanging and like methods.

In embodiments, the method can further comprise, for example, selectively decorating a surface of the self-supporting sintered or unsintered inorganic sheet with electrostatic deposition, exclusion of electrostatic deposition, or a combination thereof.

In embodiments, the method can further comprise, for example, coating the self-supporting inorganic sheet with a functional coating, such as a polymer for achieving optical properties.

In embodiments, the method can further comprise, for example, electrostatically depositing one or more dry inorganic powder layers on the self-supporting sintered or unsintered inorganic sheet to form one or more second layers, and sintering the resulting one or more second layers on the self-supporting inorganic sheet to form an article having a plurality of self-supporting inorganic sheets. In embodiments, the one or more second layers can have at least one property selected from a density, a porosity, or a combination thereof, that is different from the properties of the self-supporting sintered inorganic sheet.

In embodiments, the self-supporting sintered inorganic sheet can have a thickness, for example, of from 10 to 300 microns.

In embodiments, the sintering can be accomplished, for example, at from 1000 to 1700° C. and a hold time of from 0 mins to 1 day.

In embodiments, the electrostatically depositing the dry inorganic powder on the surface can be accomplished by, for example, electrostatically spraying the dry inorganic powder on a tape casted polymer surface. The polymer can be removed during sintering and is not part of the final self-supporting sintered inorganic sheet article. In embodiments, one can readily control or alter, for example, the density, porosity, thickness, or combinations thereof, of the resulting sheet article during the electrostatic spraying of the dry powder by, for example, changing amounts, conditions, rates, and like variable. In embodiments, the deposition surface can be, for example, a tape cast polymer.

In embodiments, the dry inorganic powder can comprise, for example, at least one of a hydroxylated silica, at least one of a silica soot, or a mixture of at least one of a hydroxylated silica, e.g., silica gel, colloidal silica, and like hydroxylated silica, and at least one of a silica soot. In embodiments, the hydroxylated silica can be spray dried prior to being deposited (i.e., spray dried to minimize or eliminate liquid content prior to being electrostatically sprayed).

In embodiments, the self-supporting green inorganic sheet after or upon sintering can have a linear shrinkage property of from greater than 3 relative % in at least one of the x, y, or z-directional axes or dimensions.

In embodiments, the resulting electrostatically deposited inorganic sourced powder sheet can be further heat treated to obtain a sheet having a linear shrinkage in any one direction or dimensions of, for example, greater than 3 relative %, greater than 4 relative %, and greater than 5 relative %, including intermediate values and ranges, e.g., 3 to 6%. The linear shrinkage property of the resulting heated sheet when cooled to ambient temperatures provides improved mechanical properties, which permits the sheet to be free-standing.

In embodiments, the shrinkage of the sheet article in the x- and y-directions after sintering is low, for example, from 0.1 to 7 relative %. In embodiments, the shrinkage in the z-direction after sintering can be significantly larger, for example, from 3 to 30 relative %, such as 5 to 25 relative % including intermediate values and ranges, which anisotropic shrinkage can produce sheet articles having exceptionally low warpage. In embodiments, if the targeted porosity of the sheet article is reduced by, for example, by changes in the electrostatic deposition process or other procedural modifications, the shrinkage of the sheet article in the x- and y-directions upon sintering can be increased, for example, to from 7 relative percent to 10 to 30 relative percent.

In embodiments, the at least one of the x, y, or z-directional axes having the largest relative linear shrinkage is the out-of-plane z axis.

In embodiments, the particles in the powder preferably can have a dielectric constant of, for example, less than about 100 to hold an electrostatic charge.

In embodiments, the self-supporting sintered inorganic sheet can have a dielectric constant, for example, of from 1.1 to less than 4, including intermediate values and ranges.

In embodiments, the self-supporting sintered inorganic sheet can have a visible light transmission property of, for example, from 75% to 99% such as a light transmission of from 95% or more, including intermediate values and ranges.

In embodiments, the self-supporting sintered inorganic sheet can have considerable flexibility and can have a bend radius of, for example, from 5 to less than 1000 mm, including intermediate values and ranges.

In embodiments, the powder selected for electrostatic deposition preferably can be fluidized and can retain a static electric charge.

In embodiments, the inorganic powder selected can have, for example, a terminal velocity in atmospheric pressure and gravity of less than 10 cm/s, and preferably less than 1 cm/s, which allows a relatively easy dispersion, and which terminal velocity can contribute to minimizing agglomeration.

In embodiments, the inorganic powder selected can be comprised of small particles of, for example, from 5 to 10,000 nm, more preferably from 20 to 500 nm, even more preferably from 30 to 200 nm, such as 100 nm, including intermediate values and ranges, which small size particles can contribute to greater sheet strength properties but can also increase porosity. In embodiments, the particles of the inorganic powder can have a surface area of, for example, from about 1 m²/g to about 380 m²/g, more preferably from 10 to 200 m²/g, such as 22 m²/g, including intermediate values and ranges.

In embodiments, the sprayed sheet preferably adheres to a substrate after spraying to enable convenient, manual or mechanical, transfer of the deposited sheet to a sintering furnace. In embodiments, the sintering can be accomplished at from 1000 to 1700° C. and a hold time of from 0 mins to 1 day depending on the material selected. In exemplary examples, fused silica was sintered at from 1150 to 1400° C. and no hold time, alumina calls for higher temperatures and longer hold times, and a titania doped silica glass can have cooler sintering temperatures compared to pure fused silica such as from 1000 to 1200° C., for example, 1050° C. Glasses generally can have shorter hold times compared to ceramics to minimize or prevent the glass devitrification (i.e., crystallization). In an exemplary glass example, the sintering ramp up rates can be, for example, of from about 5° C./min to 10° C./min to a peak temperature and then cooled down.

In embodiments, the particles in the powder preferably are not significantly electrically conducting.

In embodiments, the particles in the powder can have a preferred resistivity of, for example, greater than 10² ohm·cm.

In embodiments, the relative humidity during electrostatic spray deposition of the particles can be, for example, preferably less than about 75% at 20° C., that is for example, less than about 2% moisture in the atmosphere.

In embodiments, in a specific instance, it is desirable to have primarily z-direction shrinkage, that is the thickness or out-of-plane dimension, and have minimal x-y shrinkage, for the purpose of minimizing warping of the sheet during consolidation. In embodiments, electrostatic spray deposition can favor a larger number of particle-particle contacts in the z-direction versus those contacts in the x-y direction as a result of the large voltage drop in the z-direction. This aspect is advantageous in that it promotes initial shrinkage in favor of the z-direction and in preference over shrinkage in the x-y direction. This selective z-direction shrinkage aspect can minimize x-y warping and favor process scale-up to larger sheet dimensions for making, for example, porous silica sheets.

In embodiments, at least some adhesion of the electrostatically deposited particles to a rigid substrate is preferred and can minimize x-y shrinkage during consolidation. In embodiments, the adhesion of the electrostatically deposited particles to the substrate is preferably removable, i.e., reversible and not permanent. In embodiments, the resulting sheet is removable from the substrate after sintering, by for example, heating.

In embodiments, Grafoil® is an example of a suitable rigid or supported flexible substrate that can be selected when silica is deposited and partially consolidated on the substrate.

In embodiments, a very flexible and handle-able, porous, flat, self-supporting silica sheet was prepared using the disclosed method using a Grafoil® substrate and silica particles.

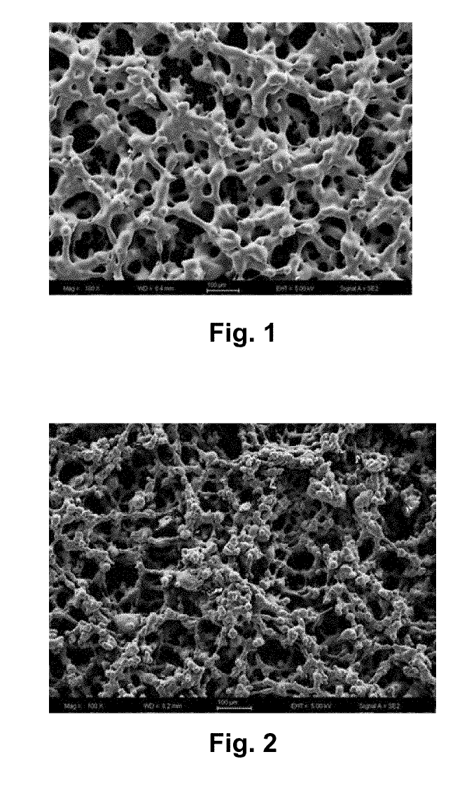

Open porosity can be determined by, for example, Hg porosimetry, but this method may provide erroneous results because of the thinness or low weight of the sample and the need for multiple stacked or layered sheets to satisfy the instrument's minimum weight requirement. Other methods for determining porosity can include, for example: density difference, e.g., measure a sample's dimensions and weight to compute sample density and compare with the theoretical density value for, for example, silica soot; and microscopy, i.e., pore volume analysis by scanning electron microscopy (SEM) (see e.g., FIGS. 1 and 2).

Referring to the Figures, FIG. 1 shows a porous silica microstructure of the disclosure created by electrostatic spray deposition of silica soot on Pt foil, and then sintered at 1392° C.

FIG. 2 shows a porous silica microstructure created by electrostatic spray deposition of silica soot on Grafoil®, and then sintered at 1392° C.

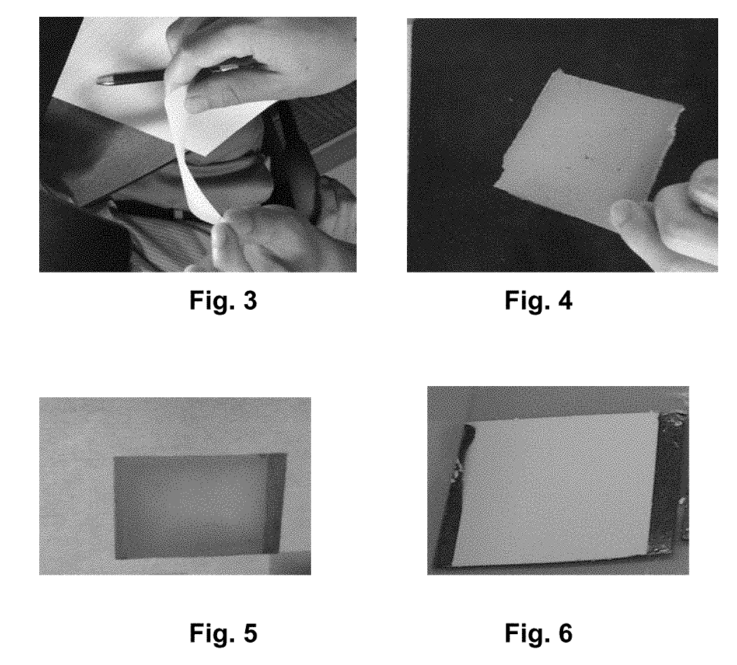

FIGS. 3 and 4 show examples of flat and flexible porous silica self-supporting sheet created by electrostatic spray deposition of silica soot and sintered at 1392° C.

FIG. 5 shows silica soot, after sintering at 1392° C. in helium on Grafoil®, the sintered sheet having a thickness of approximately 100 microns.

FIG. 6 shows silica soot as sprayed on Grafoil®.

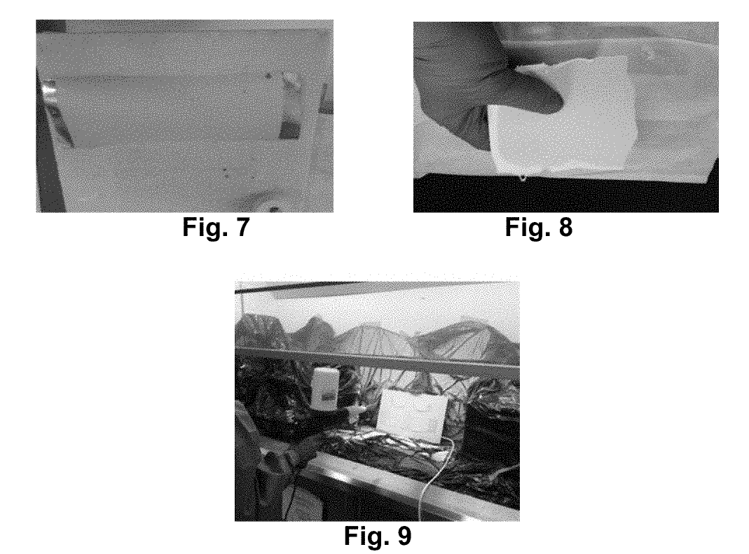

FIG. 7 shows silica soot, after sintering at 1392° C. in helium on platinum foil having a thickness of approximately 100 microns.

FIG. 8 shows a 250 micron porous, self-supporting, silica sheet after sintering at 1400° C. on Grafoil® using Daraclar® silica gel mixed with silica soot (21 m²/g).

FIG. 9 shows an image of an electrostatic spray deposition apparatus that uses a corona gun to generate electric field. FIG. 9 illustrates a setup in which the substrates are attached to a stainless steel plate that is grounded. Images (not shown) of silica soot (21 m²/g) electrostatically sprayed and sintered to 1400° C. on Grafoil® were recorded before sintering and after sintering. The images demonstrate relatively low shrinkage such as from 0.1 to 7 relative % in the x-y direction. In embodiments, the self-supporting inorganic sheet when sintered can have a linear shrinkage of, for example, from 0.01 to 0.5% in the x- and y-directions, and linear shrinkage of, for example, from 3 to 6% or more in the z-direction.

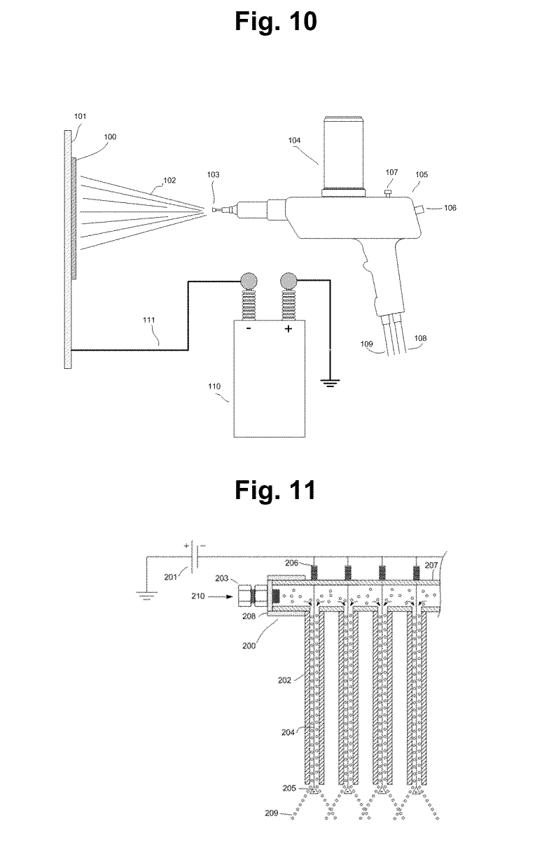

FIG. 10 shows a setup in which an opposing charge is established on the stainless steel plate. The plate is negatively biased to create a larger voltage drop between the charged particles and the substrate. This can be used to alter thickness, density, or both, of the resulting film. FIG. 10 shows a typical arrangement using a biased plate behind or backing the substrate. An aluminum or similarly conductive plate 101 has the platinum or Grafoil® substrate attached 100. The conductive plate 101 is connected to a variable high voltage DC power supply 110 negative terminal by means of a high voltage wire 111 and the high voltage power supply 110 has the positive terminal connected to earth ground. A high voltage fluidizing and charging device 105 and nozzle 103 produces a charged stream of SiO₂ particles 102 (or other similar compositions) directed to the negatively biased substrate 100 where the negative charge attracts the positively charged SiO₂ or similar particles with a force directly proportional to the negative voltage from the high voltage power supply with respect to ground. The high voltage fluidizing and charging device 105 has a reservoir to hold a batch of material for charging 104, a control to adjust the fluidizing gas flow 107, a control to adjust the charging potential 106, an AC power connection 109, and a gas inlet connection 108. The fluidizing gas can be, for example, air, N₂, Ar, He, or other inert gas, and mixtures thereof.

In embodiments, the conductive plate 101 can be configured to have either a negative or positive bias (i.e., opposite bias) depending on the charge of the particles.

FIG. 11 shows a multi-port powder corona charging system where fluidized powder 210 such as SiO₂ is conveyed into a fluidized powder inlet 203, which in turn conveys the fluidized powder into a manifold 207, which is made from a dielectric material such as alumina, Al₂O₃, and has an inner diameter of 1.5 cm to 3 cm, which is designed to avoid any flow restrictions to the fluidized powder. The fluidizing gas can be an inert material as mentioned above, which equilibrates the pressure inside the manifold and an evenly distributed volume and flow of the fluidized gas and particles distributes into one of several charging distributer tubes 202 which are made of a dielectric such as alumina, Al₂O₃. The distributer tube inner diameter can be, e.g., of from 1.5 mm to 6.0 mm. On each end of the manifold is a cap 206 used to seal the manifold tube. In each distributer tube is a thin solid and stiff wire 204, which can be AWG 24-30 made from Pt, Pt/Rh, Ag, or similar material. At the end of each distributor tube exhaust is a cone shaped electrode 205 made from the same conductive material as the wire 204 which causes the fluidized powder to be distributed in a cone shape pattern 209. The angle of the cone can be, e.g., of from 20 to 45 angular degrees depending in the degree of dispersion of the fluidized powder desired. The corona wire 204 passes through the wall of the manifold 207 and is connected to the negative terminal of a high voltage power supply 201 which may produce a high voltage in the range of 1 kVDC to 10 kVDC with the potential chosen to provide the maximum charging efficiency as required by the process. The connection to each individual corona wire 204 is made by the high voltage terminal 206. The flow of fluidized and distributed particles 209 is in the range of 10 slpm to 50 slpm in each distributer tube.

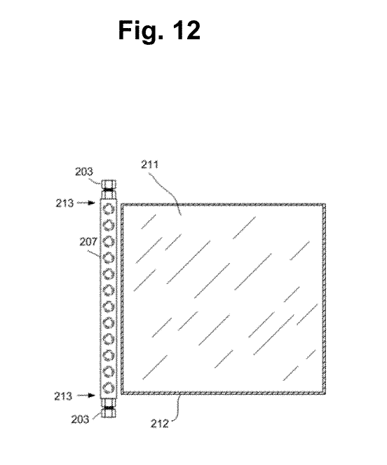

FIG. 12 shows inline corona charging head 207 with the fluidized particle injection connections 203 is shown from the top and is translated 213 across the surface of a substrate 211 at a rate of 0.5 cm/s to 10 cm/s and can be used in conjunction with a bias plate 212 below the substrate for the purpose of attracting the charged particles rigorously to the substrate surface. The translations 213 may also be a back and forth translation so, e.g., as to build multiple layers of the charge particulate on the substrate surface. In embodiments, the inline corona charging distributor head 207 can be a 2D matrix which covers a square area instead of a single line. In embodiments, individual fluidized particle corona charging distributor tubes can be in a circular arrangement such as in a ‘shower head’ and the substrate may then rotate below the shower head to build layers of charged powder. In embodiments, one can use a biased plate below or behind the substrate to increase the attractive and binding force of the charged particles on the substrate.

In embodiments, the disclosed method permits one to prepare large free-standing sheets, for example, having dimensions of from about 10 cm×10 cm to from about 100 cm×100, and for example, even greater than 1000 cm². Small free standing sheets less than 10 cm×10 cm can also be produced.

In embodiments, the disclosed method can prepare a self-supporting sheet that is, for example, dense or porous, glass or ceramic, for use in polymer infiltrated low dielectric loss PCB boards, and like microelectronic applications.

In embodiments, for display applications where the polymer index of refraction is closely matched to the inorganic self-supporting sheet index of refraction the resulting polymer filled composite sheet can have an optical transmission that is at or above about 92%.

In embodiments, a preferred glass for PCB board applications is silica or a high silica (e.g., greater than 85 wt % silica) containing glass. In embodiments, a more preferred glass is, for example, greater than 90 wt % silica and having additional components such as titania, boron, alumina, and like components or mixtures thereof.

In embodiments, the disclosure provides a low electrical loss glass or ceramic having, for example, an electrical loss of less than 1×10⁻⁴. In embodiments, a low electrical loss, glass or ceramic, having dielectric constant of less than about 4 is preferred.

In embodiments, the disclosure provides a transparent self-supporting sheet having a visible light transmission property of, for example, greater than 75%.

In embodiments, the disclosure provides a transparent self-supporting sheet which can be bent to a bend radius of, for example, from 5 to less than 100 mm without breaking, and preferably the sheet can be bent to less than 10 mm bend radius without breaking. In embodiments, the disclosure provides a polymer infiltrated self-supporting sheet, having a bend radius that is reduced compared to the non-infiltrated self-supporting sheet, for example, from 1 to 8 mm, including intermediate values and ranges, and a reduced pen drop of, for example, 9 cm or less.

In embodiments, the disclosed self-supporting sheet, such as a glass or a glass ceramic, can optionally be chemically strengthened by, for example, ion exchange, or like methods.

In embodiments, the disclosure provides at least one of a self-supporting sheet, a coating, or a powder, that can be used for ceramic filter applications such as for water filtration or CO₂ capture. The filters can have a uniform or unique porous microstructure.

In embodiments, the disclosure provides a metal oxide coating, for use in applications such as an insulating layer, for corrosion resistance, for protection of substrate layers, or to achieve a specific surface quality. In addition to metal oxides, metal nitrides can be prepared for use in articles having improved scratch resistance properties.

In embodiments, the disclosure can provide a functional coating such as a hydrophobic coating or a lipophobic or oleophobic coating that can be useful in, for example, display or life science applications.

In embodiments, the disclosure can provide a method of making an article further including, for example, introducing patterns on the surfaces of glass, or a glass and polymer laminate. Selectively charging or grounding certain portions of a pre-determined pattern to attract the charged particles to where the coating is desired and then insulating areas where the coating is undesired can permit creation of patterns on the surface of a glass, or a glass and polymer laminate.

In embodiments, the disclosed method of making can further provide various methods to selectively alter the particle deposition density and resulting particle layer thickness.

In embodiments, the disclosed method of making can include, for example, electrostatically spraying a first material such as silica soot to a certain desired density or porosity to form a first layer, then electrostatically spraying a second layer of the same or different material having a greater density (i.e., less porosity) on the surface of the first layer to form a more impact resistant coating layer. This method of making can be beneficial to applications that can have a porous sheet, e.g., for infiltration of polymer, and having a harder coating or top layer for greater impact resistance. The first layer can optionally be sintered prior to depositing the second layer if necessary.

In embodiments, the disclosed method of making can include, for example, electrostatically spraying a first material such as silica soot to a certain desired density or porosity to form a first layer, then electrostatically spraying a second layer of the same or different material having a lesser density (i.e., greater porosity) on the surface. The first layer can be sintered prior to depositing the second layer if necessary.

In embodiments, the particle deposition density and particle layer thickness can be altered via mixing of powders having a different size or size distributions. As an example, 80% coarse to 20% fines where, e.g., the fines are one fifth (⅕) the size of the coarse particles can help increase the packing density of the film during electrostatic spraying. Specific ratios can depend on the composition and actual particle morphology (e.g., shapes) and sizes.

In embodiments, the particle deposition density and particle layer thickness can be altered by, for example, applying an opposing charge to the grounded plate adjacent to the substrate used for the deposition. The opposite charging of the plate can increase the voltage drop between the charged particles and the substrates.

In embodiments, the particle deposition density and particle layer thickness can be altered by, for example, using a multi-step processes. In a first step, the powder can be electrostatically sprayed and pre-sintered. In a second step, the sprayed and pre-sintered particle layer can be dipped in a powder suspension, with or without polymers present. The powder suspension can contain the same powder with the exception of having a different particle size or the powder suspension can be an entirely different type of powder. In subsequent steps, any polymer present can be removed, and further heat treated to sinter, to strengthen, or both, the dipped particle film.

In embodiments, in an alternative process, a binder polymer can be selected and can be tape cast and used as the substrate, or alternatively, a polymer layer or polymer sheet can be attached to a substrate. Such binder polymers or polymer layers can include any suitable polymer such as a polyacrylic, a polyacrylate, a poly vinyl butryal (PVB), a poly vinyl alcohol (PVA), a polyethylene glycol (PEG), a poly vinyl acetate, a poly vinyl ester, a styrene acrylic copolymer, a cellulose ether, an ethyl cellulose, and like other cellulose binders, or combinations of binders. The binder polymer can be formulated as a non-aqueous binder, an aqueous binder, or a latex binder formulation. A metal oxide or alternative particulate powder can then be electrostatically sprayed onto the underlying polymer. The polymer binder or polymer layer can then be removed (i.e., burned out) during sintering.

In embodiments, the particle powder deposition density and particle layer thickness can be altered using, for example, a silica having hydroxyl groups such as Daraclar® silica gel commercially available from W. R Grace & Company in a 50 vol % or less Daraclar® to 50 vol % or greater of pure silica soot with a primary particle surface area of 22 m²/g. Although not limited by theory, the thickness of the resulting self-supporting sheet can be increased by, for example, 2.5 times, and the density can also be increased by, for example, 2 times, see FIG. 8. In embodiments, the density and thickness of the particle powder deposition can also depend on, for example, the sintering temperature, the porosity, and how much shrinkage occurs. In addition, the surface area of the Daraclar® is from 300 to 350 m²/g, and the surface area of the silica soot is 22 m²/g, so the bimodal particle size distribution could have contributed to superior particle packing and improved density.

In embodiments, another method to alter the density and the porosity of the sheet is to use a composition comprising a mixture of silica soot and colloidal silica (e.g., Ludox AS40). These materials can be spray dried together and then the dried mixture can be electrostatically sprayed. Table 1 lists a slurry composition that was prepared for spray drying, and the slurry composition had encouraging results for increasing the bulk density as perceived by visual inspection (actual density data analysis is in progress). The Ludox colloidal silica has a particle size of from one-third (⅓) to one-half (½) of the size of the silica soot particle size, which may be responsible for better particle packing in the formed film (i.e., electrostatically sprayed) and the resulting film (i.e., sintered sheet). The water content of the composition is substantially reduced during the spray drying process and the dried agglomerates consisting of the silica from both the colloidal and the soot sources are used for the subsequent electrostatic spraying.

TABLE 1
A silica slurry composition for spray drying.

| | Density | Mass | Volume |
|---|---|---|---|
| Material/Ingredient | (g/mL) | (g) | (mL) |
| Ludox AS-40 water (60%) | 1.00 | 375.00 | 375.00 |
| Ludox AS-40 (40%) | 2.20 | 250.00 | 113.64 |
| Silica (silica soot 22 m²/g) | 2.20 | 1000.00 | 454.55 |
| Additional water | 1.00 | 2000.00 | 2000.00 |
| Total | | 3625.00 | 2943.18 |
| Volume % solids loading | 19.31 | — | — |
| Mass % solids loading | 34.48 | — | — |

In embodiments, sintering aids can be used. The metal oxide powders can be doped, for example, with boron and like elements, to adjust thermal properties and create viscous phases during sintering.

In embodiments, the particle deposition density and particle layer thickness can be altered by, for example, heating or cooling the substrate while electrostatically spraying the particles on to a substrate.

In embodiments, the particle deposition density and particle layer thickness can be altered by, for example, selecting a suitable sintering time and temperature for each type of powder, or by changing the sintering atmospheres (N₂, helium, etc.).

In embodiments, the electrostatic spray gun can also send a stream of charged particles into a furnace and deposit them on a substrate, prior to, or during the sintering step.

In embodiments, the electrostatic spray deposition can be accomplished using, for example, atomized liquids. Atomized liquids permit various solvents, binders, or dispersants to be selected and incorporated depending on, for example, the targeted properties and product application.

In embodiments, the present disclosure is advantaged in several aspects, including for example:

The disclosed free-standing, self-supporting (e.g., a thickness of less than 250 microns, and less than 100 microns), porous sheets have been created that are flexible, flat, and handle-able.

The disclosed free-standing, self-supporting porous sheets favor initial shrinkage in the z-direction over that in the x-y direction leading to flatness and minimizing warping. This also is advantageous for scale-up processes for making porous silica. The self-supporting sheets have very uniform thicknesses since the charged particles will distribute evenly across the substrate as they are deposited.

Fully dense self-supporting sheets can be produced.

Self-supporting sheets having varying amounts of porosity and various pre-selected thicknesses can be produced.

A “glass foam” can be produced since there is low shrinkage in the x-y direction.

The sheets made by the presently disclosed method are stronger than, for example, porous sheets created by tape casting.

The electrostatically sprayed sheets can be heated to temperatures up to, for example, from 1400 to 1450° C., and still remain porous. Tape casted sheets typically must be sintered at lower temps to achieve the same porosity and are not as strong as the electrostatically sprayed sheets that have similar porosity. This is advantageous for the PCB and display applications where the porous self-supporting sheet can be infiltrated with a polymer.

Various glass, metal oxide, nitride, and carbide powders can be used provided that they can hold a static electric charge and can be fluidized when in a dry state.

Electrostatic spraying is a technique in which a dry powder is fluidized by a compressed gas and then charged by an electric field. The charged particles are attracted to a grounded plate. The charged particles will adhere to substrates, which substrates can be attached to the grounded plate or directly to the grounded plate. Electrostatic spray methods perform well on a substrate that is conductive or has a high dielectric constant. The resulting intermediate sheet can then be consolidated to form, for example, a dense or porous glass sheet product. An ultra-thin silica sheet such as having a thickness of from 10 to 250 microns, can be removed from a substrate. Alternatively, other metal oxide or non-metal oxide coatings can be made. The product sheets can be very uniform since the charged particles distribute evenly across the substrate as they are deposited. Uniformity can be characterized, for example, by having less than +/−10% variation in weight per unit area at a 1 cm² scale, and having less than +/−10% variation in weight per unit area at a 1 mm² scale. In embodiments, a preferred uniformity (i.e., homogeneity) of the product sheet can be, for example, less than from +/−5% variation, and more preferably a uniformity variation of less than +/−2.5% variation at both of the 1 cm² scale and the 1 mm² scale.

In embodiments, the electrodeposited and sintered sheet product can have a thickness of, for example, from 10 to 400 microns, from 20 to 400 microns, and from 30 to 395 microns, including intermediate values and ranges, such as 390 microns.

In embodiments, the electrostatic spray gun fluidizes and charges the source particles such as silica, which particles are then attracted to a substrate fixed to a plate that is either grounded or has an opposing charge (see FIG. 9). In embodiments, a self-supporting sheet having at least one pre-determined thickness can be formed on the substrate, i.e., sheets of various thicknesses can be formed on the substrate.

The disclosed method produces a sheet that can have high uniformity and low warpage. In exemplary examples, there is a low x-y dimension shrinkage that leads to less warpage during sintering; there is also a uniform distribution of particles on the substrate due to the attraction of the charged particles to the substrate, i.e., as the thickness of the deposited powder increases, it becomes more difficult to achieve uniformity since the substrate becomes more and more insulating; and no organic solvents or no binders need to be used. In embodiments, undesired “warpage” can present as apparent waves or ripple on the surface of the self-supporting sheet due to, for example, bending, twisting, or unevenness of the surface attributable to differences or local variations in weight per unit area or sheet thickness.

Tape casting typically has the issue of non-uniform shrinkage during sintering due to density variations in the green tape. A slip must be created to tape cast. Evaporation of the solvent during the drying of the tape is not consistent throughout the tape since the tape must be cast on a carrier film. Drying is one sided and solvent must diffuse through the tape and evaporate from the outer surface. This can cause non-uniform particle packing. Furthermore, the organic binders, plasticizers, dispersants, and volatile or combustible ingredients are preferrably removed during sintering. A dry powder can be used for electrostatic spraying and the process does not require the use of a slip with organic components and solvents.

In embodiments, the disclosed method can produce an inorganic sheet having excellent and reproducible uniformity, and the method can eliminate, for example, processing steps associated with slurries for wet spraying methods or tape casting methods.

In embodiments, the disclosed method can have a variety of applications including, for example, those mentioned below.

In embodiments, the disclosed method provides glass or ceramic ultra-thin, self-supporting, inorganic sheets for microelectronics, integrated circuit boards (e.g., printed circuit boards), or packaging applications. Sheets can be made and then fully consolidated or sintered to varying levels of porosity for applications that require infiltration with, for example, a polymer for making polymer-metal oxide composites, and like materials. In addition, layers of increasing porosity can be created for preparing, for example, a sheet that is 92% transparent, has a 3 mm bend radius, and can survive a 10 cm pen drop test for a display application. A porous inorganic substrate can be made using the disclosed electrostatic spray method and then infiltrating the resulting porous inorganic substrate with an index matching polymer. The resulting composite can satisfy a variety of optical, mechanical, and flexibility requirements, for example, a porous sheet having a glassy surface and having high scratch resistance.

Sheets, coatings, or powders for ceramic filters such as for water filtration or CO₂ capture, and which filters preferably can have uniform or unique porous microstructures.

Metal oxide coatings for use in, for example, insulating layers, corrosion resistance, protection of substrate layers, or to achieve specific surface qualities. In addition to metal oxides, metal nitrides can be made for enhancing scratch resistance properties. Hydrophobic or lipophobic/oleophobic coatings be made, and used, for example, in image display or life science applications.

Introducing patterns on the surfaces of a glass or a glass-polymer laminate. For example, by selectively charging or grounding certain portions of a pre-determined pattern, the charged particles can be selectively attracted where a coating is desired and then insulating areas where the coating is undesired allow for pattern creation on the glass or glass-polymer laminate.

In embodiments, the disclosed sheet article products can be useful in solid electrolyte applications such as in garnet membranes. In embodiments, the solid electrolyte can be, for example, hermetic, have a sheet thickness of about 20 microns, a conductivity of 1×10-4 S/cm, and sintered grain size of, for example, less than about 5 microns and about 20 microns for a stronger membrane.

Porous self-supporting sheets having uniform pore size distribution that are less than 250 microns thick, such as 100 microns thick, have been prepared (see FIGS. 1 and 2). The sheet was approximately 100 microns after sintering, flexible, could be handled, and was very flat (see FIGS. 3 and 4). As the silica particle coating thickness increases, the spray process is self-limiting as the substrate becomes more insulating and the spray deposition becomes less effective and less uniform. However, various process variations can be used to alter, for example, the porosity, density, and thicknesses of the metal oxide self-supporting sheets.

The electrostatic spray corona gun used in the making the thin self-supporting sheets was a Redline EZ100 (100 kV) model available from Redline Industries Limited. Silica powder (about 22 m²/g) was added to a container attached to the gun and fluidized using compressed air at approximately 40 psi. No other components were added to the powder. This powder was sent through a nozzle, atomized, and exposed to an electric field created by the corona gun. Grafoil® or platinum surface substrates were attached (e.g., clamped) to a stainless steel grounded plate. The sprayed charged silica powder was attracted to the plate and coated the surface substrate. Since the powder adhered well to the Grafoil® and Pt substrates, even after the electric field was removed, the powder coated surface substrates were easily transferred to a furnace and sintered at, for example, 1390 to 1400° C. The resulting sintered silica sheets were then released from the substrate with, for example, a small razor blade underneath the sheet and lifting the sheet off of the surface substrate. The released silica sheet remained intact and without cracking.

### EXAMPLES

The following Examples demonstrate making, use, and analysis of the disclosed articles and methods in accordance with the above general procedures.

### Example 1

Method of Making a Self-Supporting Silica Sheet by Electrostatic Spraying

Referring again to the Figures, FIG. 9 and FIG. 10 show experimental setups that can be used for electrostatic spraying. The composition for the sheets shown in the images in FIGS. 2, 3, 4, 5, and 6, is pure silica having a primary particle surface area of about 22 m²/g. There are no other components added.

The following procedure was used to produce the self-supporting silica sheets in FIGS. 2, 3, 4, 5, and 6. A compressed air line and a power cord were attached to an electrostatic spray gun and the air pressure was set to about 40 to 45 psi. A container was filled with a desired amount of silica soot powder and the container was attached to the electrostatic spray gun. A chlorine cleaned Grafoil® was attached to a stainless steel plate or a similarly conductive plate. The conductive plate was grounded. The power was set to 100 kV.

A corona gun was aimed at the Grafoil® on the conductive plate and the trigger pulled to fluidize the powder and generate and electric field. Silica powder was sprayed onto surface(s) until a desired thickness of the silica sheet is achieved. The Grafoil® having the deposited silica sheet was carefully removed from the conductive plate. Another piece of Grafoil® was placed on top of the deposited silica side of the sheet.

The deposited silica sheet situated between the two Grafoil® surfaces was sintered in a helium atmosphere to a top soak of about 1400° C. sintering temperature. The following exemplary cycle was used: 300° C./hr to 300° C.; 500° C./hr to 1400° C.; no hold; cool down at 500 to 200° C./hr or at a faster furnace cool down rate. The sintered silica sheet was removed from the Grafoil® surface by carefully placing a sharp edge such as a razor blade underneath the resulting silica sheet and then gently lifting the self-supporting, free-standing, sheet off of the Grafoil® sheet surface.

### Example 2 (Prophetic)

Treating a Porous Sheet Article by a Contacting the Porous Sheet Article with a Coupling Agent

A coupling agent, such as a silane, is contacted with a porous sheet article of Example 1 or like articles, to coat the internal surfaces, interstices, and like void volume of the article. Contacting can be accomplished by any suitable method, for example, dip coating, tape casting, slot die coating, electrostatic spraying, or like coating methods. Optional removal of moisture from the surface of the porous sheet or from the bulk of the porous sheet prior to contacting with the coupling agent is preferred. Methods for contacting a porous inorganic substrate with a coupling agent and subsequent polymer infiltration are known in the art (see for example, Bona, et al., “Characterization of a polymer-infiltrated ceramic-network material”, Dent Mater. 2014 May; 30(5): 564-569, mentions making and characterization of polymer-infiltrated-ceramic-network (PICN)).

### Example 3 (Prophetic)

Polymer Infiltration of Porous Sheet

Methods for infiltrating porous inorganic substrates with polymers are known in the art (see e.g., WO 2011/005535A1 mentions a composite having co-continuous ceramic and polymer phases, the ceramic phase having an interconnected network of pores and an interconnected network of truss-like structures). Example methods include dip coating, tape casting, slot die coating, infiltrating in a glove box with controlled atmosphere (for example, vacuum, helium, N₂, argon) to remove moisture and air prior to infiltration. Vacuum and heat can be applied, e.g., for higher viscosity polymers. For thermosets, the liquid is infiltrated such as by one or more of the above methods, and then cured to crosslink the polymer in the pores. For thermoplastics, one or more of the above methods can be used. Alternatively, one can add monomer or low molecular weight oligomers to a thermoplastic polymer, for example, styrene monomer or oligomers can be added to polystyrene, to lower molecular weight and viscosity. The polymer infiltration can be accomplished with, for example a porous sheet, such as made from silica as in Example 1, or a porous silica sheet that is treated with a coupling agent as in Example 2.

### Example 4 (Prophetic)

Continuous Porous Sheet Formation

The disclosed method can be modified to perform sintering and porous glass, porous ceramic, or porous glass-ceramic sheet formation in a continuous fashion. A feed roll can provide a carrier substrate or carrier belt such as graphite, steel, glass, or like flexible and durable carrier stock. The carrier substrate or carrier belt can optionally be electrostatically charged to facilitate reception of the spray particles. The feed roll carrier substrate or carrier belt passes in close proximity (i.e., above, below, or on a side) an electrostatic spray gun that delivers, for example, silica particles to form a continuous thin layer on the carrier substrate or carrier belt. The silica layer on the carrier substrate or carrier belt next passes through a furnace to consolidate the silica layer. Thereafter, a take up roll receives the consolidated silica layer on the carrier substrate or carrier belt and stored or used in further processing. The consolidated silica layer on the carrier substrate or carrier belt can optionally be imbibed with polymer and cured before or after being wound on the take up roll. The continuous sintering takes advantage of, for example: a main stress-bearing component of the rolling process being carried by the carrier substrate and not the considerably weaker ceramic or glass (e.g., silica) thin film layer that is being produced; high temperature stability of carrier substrate that can facilitate consolidation or bonding of ceramic or glass thin film layer; adhesion release between the substrate and the sprayed and consolidated thin film layer and the carrier substrate; flexibility of carrier substrate and the thin film layer produced; and the ability to strip the resulting thin film from the carrier before or after the carrier substrate is taken up on the take up roll.

The disclosure has been described with reference to various specific embodiments and techniques. However, it should be understood that many variations and modifications are possible while remaining within the scope of the disclosure.

What is claimed is:

1. A method of making a self-supporting inorganic sheet, comprising:
electrostatically depositing a dry inorganic powder on a surface to form an inorganic layer on the surface; and
sintering the resulting inorganic layer to form a self-supporting sintered inorganic sheet.

2. The method of claim 1 wherein the dry inorganic powder is a source of at least one of a glass, a metal oxide, a metal carbide, a metal nitride, or a mixture thereof.

3. The method of claim 1 further comprising, prior to sintering, separating the inorganic layer from the surface to provide the sintered self-supporting inorganic sheet.

4. The method of claim 1 further comprising separating, after sintering, the sintered inorganic sheet from the surface to provide the self-supporting sintered inorganic sheet.

5. The method of claim 1 further comprising, prior to electrostatically depositing the dry inorganic powder, the dry inorganic powder is fluidized and electrostatically charged.

6. The method of claim 1 further comprising infiltrating the self-supporting sintered inorganic sheet with at least one polymer.

7. The method of claim 6 wherein the at least one polymer is selected from at least one of a polymer melt, a cross-linkable polymer, or a combination thereof.

8. The method of claim 6 wherein the at least one polymer has a refractive index that is the same or similar to the refractive index of the self-supporting inorganic sheet.

9. The method of claim 1 further comprising chemical strengthening the self-supporting sintered inorganic sheet.

10. The method of claim 1 further comprising selectively decorating a surface of the self-supporting sintered inorganic sheet with electrostatic deposition of particles, exclusion of electrostatic deposition of particles, or a combination thereof.

11. The method of claim 1 further comprising coating the self-supporting sintered inorganic sheet with a functional coating.

12. The method of claim 1 further comprising electrostatically depositing one or more dry inorganic powder layers on the unsintered self-supporting inorganic sheet to form one or more second layers, and sintering the resulting one or more second layers on the unsintered self-supporting inorganic sheet to form an article having a plurality of combined self-supporting sintered inorganic sheets.

13. The method of claim 12 wherein the one or more second layers has at least one property selected from a density, a porosity, or a combination thereof, that is different from the properties of the self-supporting sintered inorganic sheet.

14. The method of claim 1 wherein the self-supporting sintered inorganic sheet is from 40 to 100% dense and is from 60 to 0% porous.

15. The method of claim 1 wherein the self-supporting sintered inorganic sheet has a thickness of from 10 to 400 microns.

16. The method of claim 1 wherein the sintering is accomplished at from 1000 to 1700° C. and a hold time of from 0 mins to 1 day.

17. The method of claim 1 wherein electrostatically depositing the dry inorganic powder on the surface is accomplished by electrostatically spraying the dry inorganic powder on a tape casted polymer surface.

18. The method of claim 1 wherein the dry inorganic powder comprises at least one of an hydroxylated silica, at least one of a silica soot, or a mixture of at least one of an hydroxylated silica and at least one of a silica soot.

19. The method of claim 1 wherein the self-supporting sintered inorganic sheet has a linear shrinkage property of from 3 relative % or more in at least one of the x, y, or z-directional axes or dimensions.

20. The method of claim 19 wherein the at least one of the x, y, or z-directional axes is the out-of-plane z axis.

21. The method of claim 1 wherein the sintering the resulting inorganic layer results in a linear shrinkage of from 0.01 to 0.5 relative % in the x- and y-directions, and a linear shrinkage of from 3 to 30 relative % in the z-direction.

22. The method of claim 1 wherein the self-supporting sintered inorganic sheet has a dielectric constant of from 1.1 to less than 4.

23. The method of claim 1 wherein the self-supporting sintered inorganic sheet has a visible light transmission property of from 75% to 99%.

24. The method of claim 1 wherein the self-supporting sintered inorganic sheet has a bend radius of from 5 to less than 1000 mm.

25. The method of claim 1 further comprising contacting the self-supporting sintered inorganic sheet with a coupling agent, and then infiltrating the resulting coupling agent contacted self-supporting sintered inorganic sheet with a polymer compatible with the coupling agent contacted self-supporting sintered inorganic sheet.

26. An article made by the method of claim 1.
